(19) United States
(12) Patent Application Publication
(10) Pub. No.: US 2011/0193818 A1
(43) Pub. Date: Aug. 11, 2011

(54) PROXIMITY-SENSING PANEL

(75) Inventors: Yi-Ta Chen, Taoyuan County (TW); Jun-Hua Yeh, Taoyuan County (TW)

(73) Assignee: Edamak Corporation, Taoyuan County (TW)

(21) Appl. No.: 13/019,614

(22) Filed: Feb. 2, 2011

(30) Foreign Application Priority Data
Feb. 5, 2010 (TW) 099103566
Mar. 29, 2010 (TW) 099109402
Sep. 3, 2010 (TW) 099129854
Feb. 1, 2011 (TW) 100104018

(51) Int. Cl. G06F 3/041; G06F 3/045; G06F 3/042; G06F 3/044

(52) U.S. Cl. 345/174; 345/173; 345/175

(57) ABSTRACT

A proximity-sensing panel and a proximity-sensing is provided. The proximity-sensing panel includes a substrate panel, one or more proximity-sensing unit and one or more sensing circuit. The proximity-sensing unit is formed on one or more perimeter of the substrate panel. The proximity-sensing unit senses an approaching operation of an object to generate a proximity-sensing signal. The sensing circuit receives the proximity-sensing signal and generates a control signal to initiate a proximity touch control.

### CROSS-REFERENCES TO RELATED APPLICATIONS

This non-provisional application claims priority under 35 U.S.C. §119(a) on Patent Application No. 99103566, 99109402, 99129854, and 100104018 filed in Taiwan, R.O.C. on Feb. 5, 2010, Mar. 29, 2010, Sep. 3, 2010, and Feb. 1, 2011, the entire contents of which are hereby incorporated by reference.

### BACKGROUND OF THE INVENTION

1. Field of Invention

The present invention relates to a panel, in particular, to a panel capable of proximity-sensing.

2. Related Art

Accompanying with developments of optoelectronics technology, proximity switching device has been massively applied to various machines, e.g. smart phone, transportation ticketing system, digital camera, remote control, liquid crystal display (LCD) and etc. A common proximity switching device includes a proximity sensor and a touch panel, mainly used to switch the system status. The operation of proximity sensor is in a sensing range to proximally sense the position of an object that is approaching closer with or without contacting to the object. The proximity sensor converts the sensed signal into an electrical signal; the system or machine will respond according to such electrical signal to control the system status.

The proximity sensor is also known as proximity switch, applied on many LCD televisions, power switches, switches for home appliances, security systems, handheld remote control and mobile phone. In the recent years, the proximity sensor becomes an irreplaceable role for these devices and apparatuses. The proximity sensor is adapted to detect if an object is approaching closer and allow a controller to understand the current position of the object. Take home appliance applications as example, the proximity sensors are massively used on the control of light sources; the user only needs to reach his hand approach to the proximity sensor or actually touch the proximity sensor, the light sources may be turned ON or OFF according to the sensed signal of the proximity sensor. Proximity sensors have various appearances e.g. rectangular type, round pillar type, round-hole type, slot type and multi-point type. It can also be classified according to the principles of proximity sensing, including inductive sensing, capacitive sensing, photoelectric sensing and magnetic sensing.

Please refer to FIG. 1, which is a system block diagram of a capacitive proximity-sensing system 100. The capacitive proximity-sensing system 100 includes an object 10, a proximity-sensing unit 101, a sensing circuit 105 and a microprocessor 106. When the object 10 is approaching close to the proximity-sensing unit 101, the capacitance sensed by the proximity-sensing unit 101 varies according to the distance of the object 10. Meanwhile, an oscillation signal is generated from the oscillator 102 according the generated oscillation frequency/amplitude that varies on different distances of the object 10. The detection circuit 103 converts the oscillation signal into a fixed direct-current voltage and send to the output circuit 104. The output circuit 104 is adapted to receive the fixed direct-current voltage, increase the driving power and then send as an output signal to the microprocessor 106 or a controlled load terminal.

Nowadays, various display panels have been applied to different apparatuses. To embody the interactive concept of touch panel, a conventional technology is to install proximity-sensing boards surrounding a touch panel; such proximity-sensing board includes a circuit board, a proximity-sensing unit, a sensing circuit and a microprocessor. FIG. 2 shows a top view of a conventional touch panel, which includes a touch panel 130, proximity-sensing units 140 and circuit boards 150. FIG. 3 shows a structural side view of a conventional capacitive touch panel.

Referring to FIG. 2 and FIG. 3, the conventional technology is to install at least one additional circuit board and dispose the proximity-sensing units on each of the circuit boards. Such approach will increase the cost and the complexity of system cable routing, and eventually make the system difficult to be integrated. Therefore, how to reduce the cost of implementing the proximity-sensing unit(s) onto the interactive panel and reduce the complexity of system cable routing, becomes a critical issue of the application on interactive panel.

### SUMMARY OF THE INVENTION

Accordingly, the present invention provides a proximity-sensing panel. The proximity-sensing panel includes a substrate panel and proximity-sensing unit(s). In the conventional technology, at least one additional circuit board with proximity-sensing unit(s) is required with at least one proximity-sensing unit disposed thereon. As disclosed in the embodiments of the present invention, proximity-sensing units are formed onto the substrate panel during producing the substrate panel, thereby reduces the cost and the complexity of system cable routing.

In an embodiment according to the present invention, a proximity-sensing panel includes a substrate panel, one or more proximity-sensing unit and one or more sensing circuit. The proximity-sensing unit is formed on a perimeter of the substrate panel. The substrate panel includes a touch surface to receive a touch input. The proximity-sensing unit senses an approaching operation of an object and generates a corresponding proximity-sensing signal. A sensing circuit is electrically connected to the proximity-sensing unit to receive the proximity-sensing signal and generate a control signal accordingly to initiate a proximity control.

In another embodiment according to the present invention, the proximity-sensing unit is selected from a self-capacitance proximity-sensing unit, a mutual-capacitance proximity-sensing unit, an inductive proximity-sensing unit, a photoelectric proximity-sensing unit and a magnetic proximity-sensing unit. The structure of two electrodes of the mutual-capacitance proximity-sensing unit may select from Dual Parallel Rectangles, Concentric Circles, Arc Surrounding Circle, Concentric Rectangles and Concentric Rectangular Labyrinth. The proximity-sensing unit may have different shapes such as round shape, rectangular shape, elliptic shape, star shape, heart shape, spiral shape, and hollow shape. The proximity-sensing unit may include a light transmitter for transmitting a light and a light receiver for receiving the transmitted light and generating the proximity-sensing signal according to a light intensity of the transmitted light. The proximity-sensing unit may include a magnetic sensing element to sense an eternal magnetic object; the proximity-sensing signal may be generated when two switch contacts of the magnetic sensing element are contacted to connect with each other.

In another embodiment according to the present invention, the substrate panel may be a projective capacitive touch panel, a surface capacitive touch panel, a resistive touch panel, an ultrasonic touch panel, an infrared touch panel, an OLED substrate panel, a LCD substrate panel, an EPD substrate panel, a glass substrate panel, a plastic substrate panel and an acrylic substrate panel. The proximity-sensing unit may be selectively formed on a top surface, a bottom surface, or a lateral surface of the substrate panel, or on both the top surface and bottom surface of the substrate panel. In another embodiment according to the present invention, the proximity-sensing unit is formed inside or outside the substrate panel. The substrate panel may further include a function area adapted for non-proximity touch control and the proximity-sensing unit is formed on the perimeter outside the function area; wherein the substrate panel is a non-proximity touch panel, or a display panel embedded with in-cell non-proximity touch control sensors. The substrate panel may further include a function area adapted to display images and the proximity-sensing unit is formed on the perimeter outside the function area; wherein the substrate panel is a display panel without touch control sensors.

In another embodiment according to the present invention, the substrate panel includes a projective capacitive type touch panel with a substrate layer, a first electrode layer forming at a top side and a second electrode layer forming at a bottom side; the proximity-sensing units being selectively formed at the top surface of the first electrode layer, at the bottom surface of the second electrode layer, or at both the top surface of the first electrode layer and the bottom surface of the second electrode layer. The substrate panel may include a resistive type touch panel with a first substrate layer, a spacer layer having at least one spacer and a second substrate layer; and the proximity-sensing unit is formed on the inner surfaces of the first substrate layer and the second substrate layer. The substrate panel may include a cover lens with a touch panel under the cover lens; at least a portion of the touch panel with a display panel located under the touch panel is assembled inside a housing; the cover lens covers on at least one side of the housing and the proximity-sensing unit is formed on an inner surface or an outer surface of the cover lens. The substrate panel may include a cover lens with an energy transmitter and an energy receiver located on an outer surface of the cover lens; the cover lens, the energy transmitter, the energy receiver and a display panel located underneath the cover lens are assembled inside a housing with the touch surface of the cover lens exposed outwardly; and the proximity-sensing unit is formed on an inner surface or the outer surface of the cover lens.

According to another embodiment, a proximity-sensing method of a panel is also disclosed in parallel. The panel includes a substrate panel, proximity-sensing units and sensing circuits; wherein the substrate panel includes a touch surface to receive a touch input and the sense circuits electrically connect with the proximity-sensing units. And the method includes the following steps. (A) Forming the proximity-sensing units on perimeter(s) of the substrate panel. (B) Sense an approach operation of an object and generating a proximity-sensing signal by the proximity-sensing unit. (C) Receive the proximity-sensing signal from the proximity-sensing unit and generate a control signal accordingly to initiate a proximity control.

Preferred embodiments of the present invention and efficacies thereof will be illustrated in detail below with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a system block diagram according to a capacitive proximity-sensing system in the conventional technology;

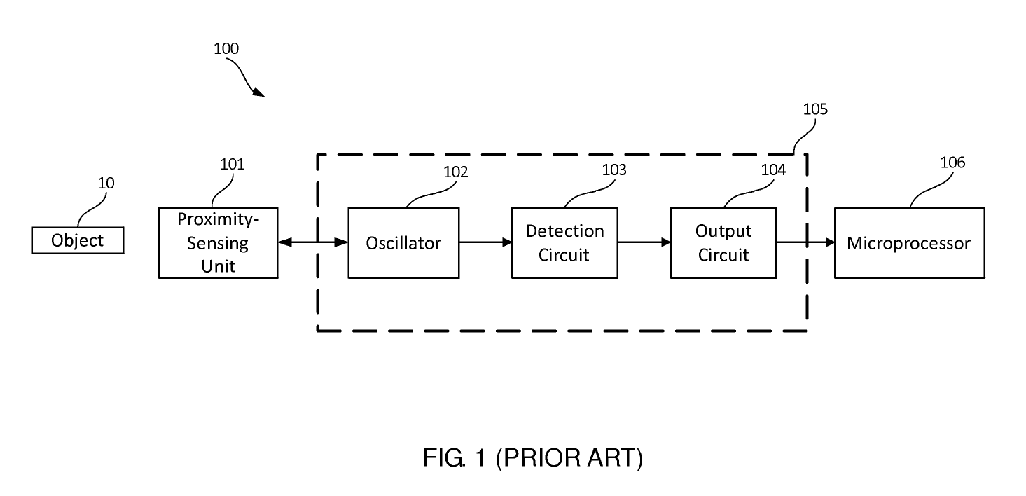

FIG. 2 is a top view of a conventional touch panel;

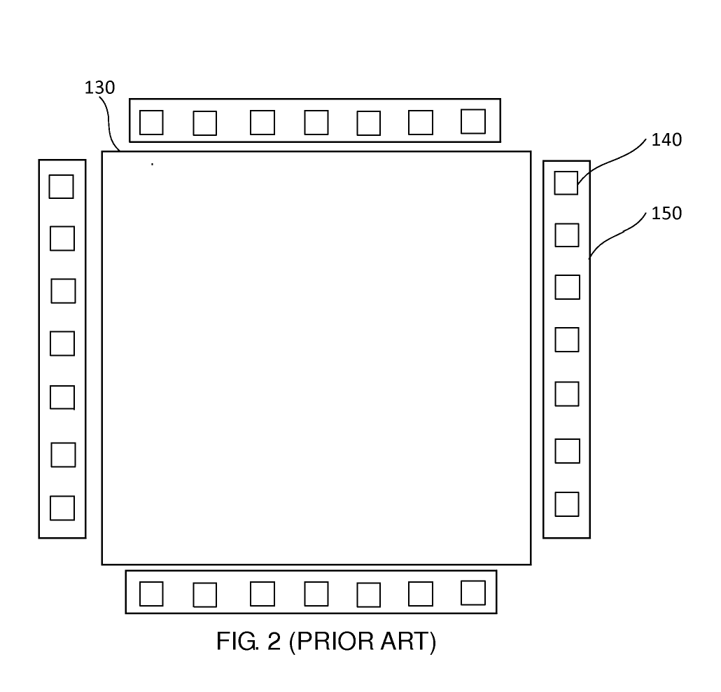

FIG. 3 is a structural view of a conventional touch panel;

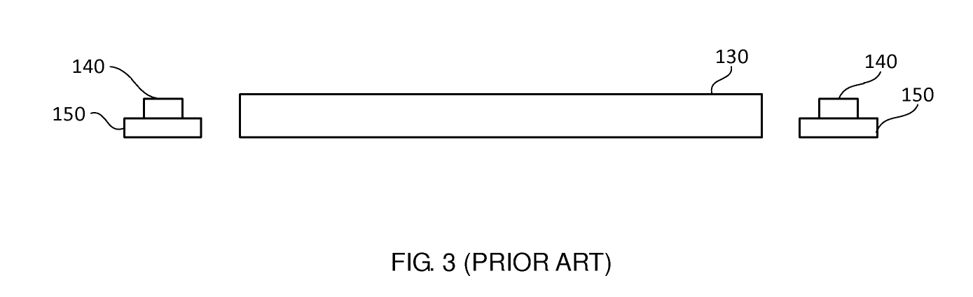

FIG. 4 is a system block diagram of a proximity-sensing panel according to an embodiment of the present invention;

FIG. 5 is a top view of a proximity-sensing panel according to another embodiment of the present invention;

FIG. 6 is a top view of a proximity-sensing panel according to another embodiment of the present invention;

FIG. 7 is a top view of a proximity-sensing panel according to another embodiment of the present invention;

FIG. 8 is a cross-sectional structural view of a capacitive proximity-sensing panel according to another embodiment of the present invention;

FIG. 9 is a cross-sectional structural view of a resistive proximity-sensing panel according to another embodiment of the present invention;

FIG. 10 is a cross-sectional structural view of an all-flat capacitive type proximity-sensing panel according to another embodiment of the present invention;

FIG. 11 is a cross-sectional structural view of an all-flat resistive type proximity-sensing panel according to another embodiment of the present invention;

FIG. 12 is a cross-sectional structural view of an optical-type proximity-sensing panel according to another embodiment of the present invention;

FIG. 13 is a cross-sectional structural view of an ultrasound-wave type proximity-sensing panel according to another embodiment of the present invention;

FIG. 14 is a system block diagram of a proximity-sensing panel with capacitive proximity-sensing units according to another embodiment of the present invention;

FIG. 15 is a system block diagram of another proximity-sensing panel with capacitive proximity-sensing units according to another embodiment of the present invention;

FIG. 16 is a system block diagram of another proximity-sensing panel with capacitive proximity-sensing units according to another embodiment of the present invention;

FIG. 17 is a system block diagram of another proximity-sensing panel with capacitive proximity-sensing units according to another embodiment of the present invention; and

FIG. 18 is a system block diagram of another proximity-sensing panel with capacitive proximity-sensing units according to another embodiment of the present invention.

### DETAILED DESCRIPTION OF THE INVENTION

Disclosed in the following embodiments of the present invention is mainly a proximity-sensing panel, which includes a substrate panel and at least one proximity-sensing unit. By forming the proximity-sensing unit on a perimeter of various types of the substrate panel, the total manufacturing cost and the complexity of system cable routing are reduced. The applied substrate panel will have the function of proximity-sensing to achieve an enhanced human-machine interaction. The proximity-sensing unit is formed on the narrow perimeter of the substrate panel during the original manufacturing processes of the substrate panel but without affecting those procedures treated on a functional area of the substrate panel, thereby greatly reducing the manufacturing costs of installing the proximity-sensing unit.

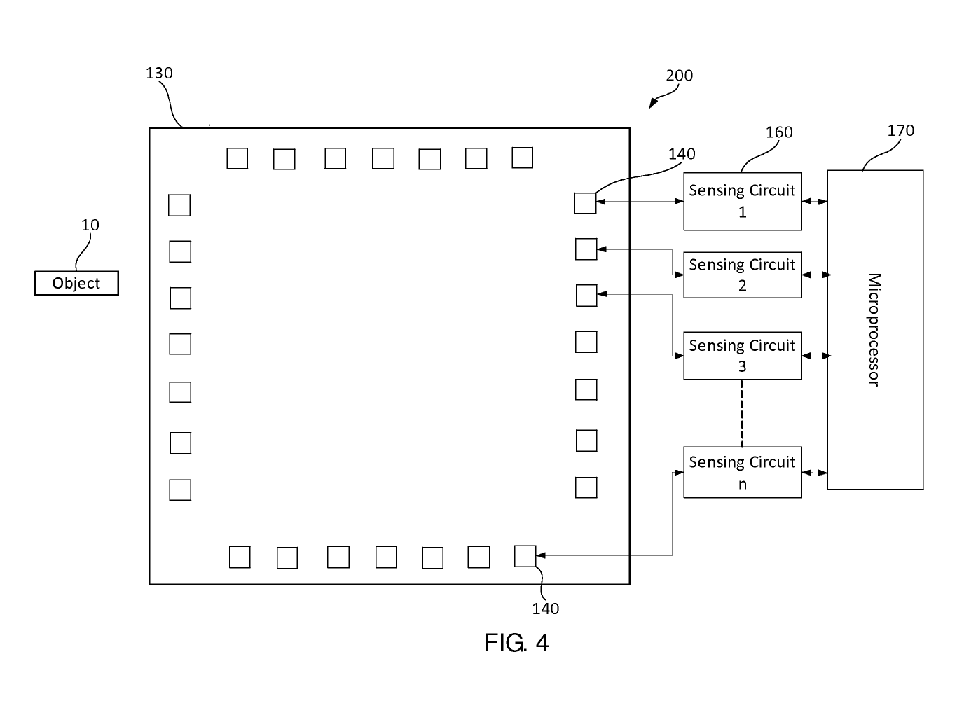

Refer to FIG. 4, which is a system block diagram of a proximity-sensing panel 200 according to an embodiment of the present invention. The proximity-sensing panel 200 includes: a substrate panel 130, one or more proximity-sensing unit 140 and one or more sensing circuit 160. The proximity-sensing unit 140 is formed on a perimeter of the substrate panel 130. The substrate panel 130 has a functional area for touch control (non-proximity) or for displaying images, and the substrate panel 130 includes a touch surface to receive a touch input; wherein the touch input may be a direct touch contact (by human hand, a stylus or any object) on the substrate panel 130 or on any other connected touch control device; the touch input may be from a non-proximity touch control device or proximity touch control device. The proximity-sensing unit 140 may sense an approaching operation of an object 10 and generate a proximity-sensing signal accordingly. The characteristic change of the proximity-sensing signal varies according to the distance between the object 10 and the proximity-sensing unit 140. The sensing circuit 160 is electrically connected to the proximity-sensing unit 140 to receive the proximity-sensing signal and generate a control signal accordingly to initiate a proximity control. The microprocessor 170 electrically connects with the sensing circuit 160, receives the control signal and calculates to generate coordinate information (X, Y). The microprocessor 170 uses the coordinate information (X, Y) to determine a direction of a user's gesture; for example: the object 10 moving from left to right, from right to left, from inclined left to inclined right, from inclined right to inclined left, from top to bottom, from bottom to top, or dual-objects' moving outwardly or inwardly to enlarge or shrink. Therefore, multiple interaction gestures between the user and different types of touch panel may be realized.

The proximity-sensing unit 140 may be selected from the group consisting of: a capacitive proximity-sensing unit, an inductive proximity-sensing unit, a photoelectric proximity-sensing unit and a magnetic proximity-sensing unit. In another embodiment, a single type or multiple types of the proximity-sensing units 140 may be installed on the substrate panel 130. The proximity-sensing unit 140 may be on a perimeter of the substrate panel outside the functional area (for touch control or for displaying images) of the substrate panel 130.

For a capacitive type of proximity-sensing unit, the characteristic change of the proximity-sensing signal varies according to the distance between the object 10 and the proximity-sensing unit; wherein the characteristic of the proximity-sensing signal means changes of a sensed capacitance. The sensing circuit 160 has an oscillation circuit that changes its oscillation frequency/amplitude according to the sensed capacitance, which generates a control signal according to the oscillation frequency/amplitude and sends to the microprocessor 170 to initiate a proximity control.

For an inductive type of proximity-sensing unit, the characteristic change of the proximity-sensing signal varies according to the distance between the object 10 and the proximity-sensing unit; wherein the characteristic of the proximity-sensing signal means changes of a sensed inductance. The oscillation circuit of the sensing circuit 160 changes its frequency/amplitude according to the sensed inductance, generates the control signal according to such frequency/amplitude and outputs to the microprocessor 170 to initiate a proximity control.

The shapes of the capacitive-type and inductive-type of proximity-sensing unit may be selected from the group consisting of round shape, rectangular shape, elliptic shape, star shape, heart shape, spiral shape, hollow shape or any other shape.

A photoelectric-type of proximity-sensing unit may include a light transmitter and a light receiver. The principle is to use the light transmitter to transmit as a light source, which may be infrared. The photoelectric-type of proximity-sensing unit receives a light reflected from an object surface and generated a light signal; wherein the sensing circuit 160 generates electrical signals according the received light intensity of the light signal and sends to the microprocessor 170.

A magnetic type of proximity-sensing unit is a magnetic sensing element; the operation principle is to use an external magnetic object to approach the proximity-sensing unit. Such magnetic proximity-sensing unit includes two iron reeds as switch contacts. When a magnetic object is approaching, the iron reeds of the magnetic-type proximity-sensing unit sense tremendous magnetism to make the two iron reeds contact and electrically connect with each other. The sensing circuit 160 generates electrical signals according the sensed magnetism and outputs to the microprocessor 170.

In different embodiments, the proximity-sensing unit 140 may be formed on: a top surface of the substrate panel 130, a bottom surface of the substrate panel 130, a lateral surface of the substrate panel 130, both the top and bottom surfaces of the substrate panel 130, and/or formed on perimeter(s) inside or outside the substrate panel 130. The substrate panel 130 includes a touch surface to receive a touch input. In different embodiments, the substrate panel of the proximity-sensing panel may be any element forming at least the major portion of a touch sensing panel, or may be a display panel with in-cell or added touch sensing panel. The substrate panel may be selected from the group consisting of projective-capacitive touch panel, surface-capacitive touch panel, resistive touch panel, ultrasound touch panel, infrared touch panel, OLED (Organic Electroluminescent Display) panel, liquid crystal display panel, EPD (E-Paper Display) substrate panel, glass substrate panel, plastic substrate panel and an acrylic substrate panel, or any combination thereof. EPD (E-Paper Display) means a reflective-type display such as electro-phoretic display, Cholesteric LCD, MEMS (Micro-Electro-Mechanical Systems) reflective display, Electrowetting e-paper display, or QR-LPD (Quick Response Liquid Powder Display).

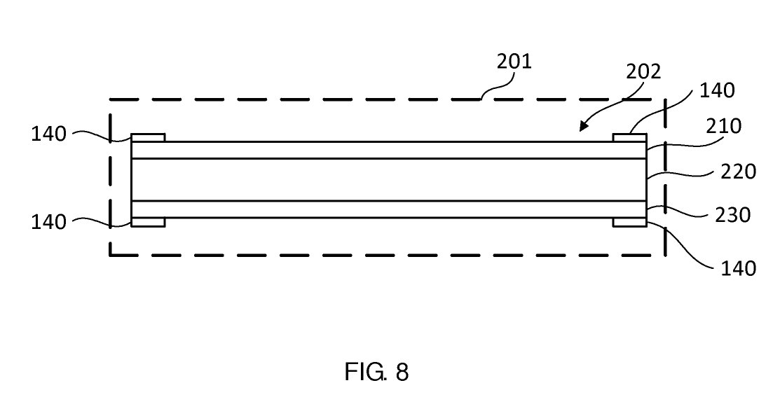

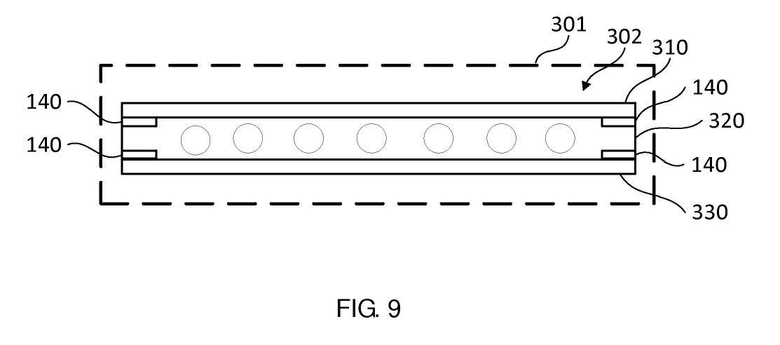

A direct touch operation (touch input) on the substrate panel itself or a touch control from an added touch-input sensor (such as laser/light touch sensor, magnetic touch sensor, infrared touch sensor or ultrasound touch sensor) may initiate displaying of an image (anything shown on a display). In different embodiments, the substrate panel may be a non-proximity touch panel, as a pure display panel without touch control sensor/function, as a display panel embedded with in-cell non-proximity touch control sensors (non-proximity touch sensors such as photo sensors, capacitive sensors, pressure sensors or switching spacers), as a display panel with added non-proximity touch sensors (such as laser/light touch sensor, magnetic touch sensor, infrared touch sensor or ultrasound touch sensor) or simply a portion of a touch sensing panel (such as glass substrate panel, a plastic substrate panel and an acrylic substrate panel that can be used as the cover lens of any touch panel and/or display panel to form an all-flat or frameless touch screen). Later a projective capacitive touch panel formed as the substrate panel will be further introduced in FIG. 8; and a resistive touch panel formed as the substrate panel will be further introduced in FIG. 9.

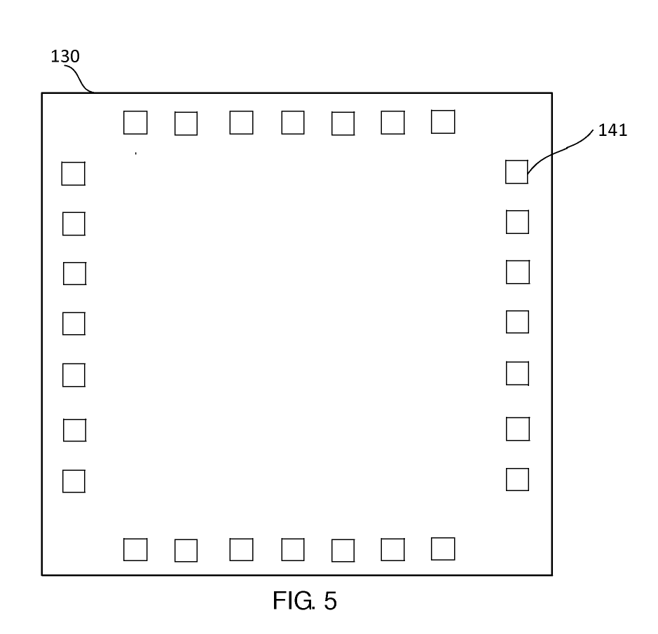

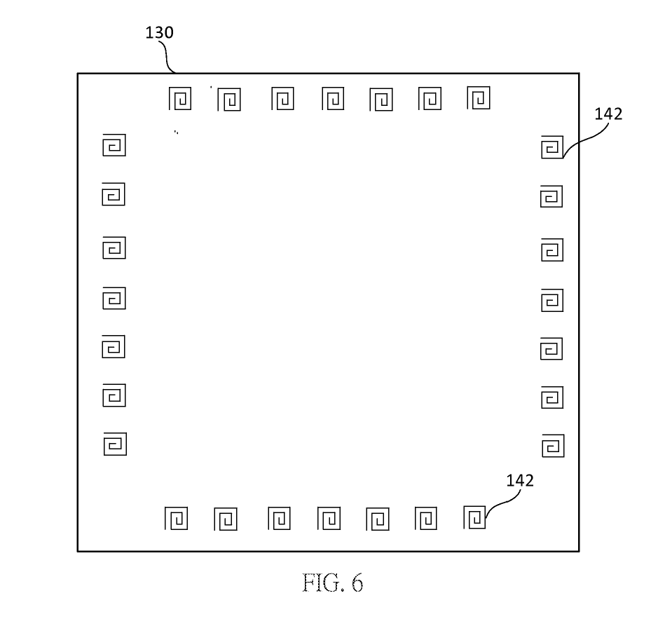

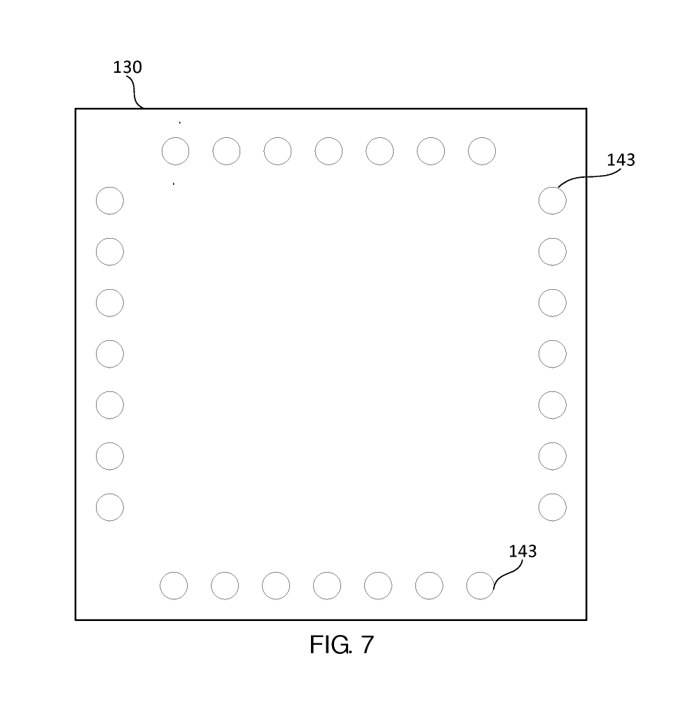

FIG. 5, FIG. 6 and FIG. 7 illustrate three embodiments of the substrate panel, in which capacitive-type or inductive-type proximity-sensing units are installed on the substrate panel 130.

FIG. 5 is a top view of a proximity-sensing panel according to another embodiment of the present invention; wherein the proximity-sensing unit 141 is formed in a rectangular shape.

FIG. 6 is a top view of a proximity-sensing panel according to another embodiment of the present invention; wherein the proximity-sensing unit 142 is formed in a spiral shape.

FIG. 7 is a top view of a proximity-sensing panel according to another embodiment of the present invention; wherein the proximity-sensing unit 143 is formed in a round shape.

Subsequently, FIG. 8 and FIG. 9 will illustrate two embodiments regarding to the positions of the proximity-sensing units formed on the substrate panel.

FIG. 8 is a structural view of a capacitive proximity-sensing panel according to another embodiment of the present invention. A capacitive proximity-sensing touch panel 201 includes a substrate panel 202 and proximity-sensing units 140. The substrate panel 202 is a projective capacitive type touch panel, which includes a substrate layer 220, a first electrode layer 210 forming at a top side of the substrate layer 220, and a second electrode layer 230 forming at a bottom side of the substrate layer 220. The proximity-sensing units 140 may be formed at the top surface of the first electrode layer 210, and/or at the bottom surface of the second electrode layer 230. Namely, the proximity-sensing units 140 may be formed on one or more perimeter(s) outside the substrate panel 220.

FIG. 9 is a structural view of a resistive proximity-sensing panel according to another embodiment of the present invention. A resistive-type proximity-sensing touch panel 301 includes a substrate panel 302 and proximity-sensing units 140. The substrate panel 302 is a resistive type touch panel, which includes a first substrate layer 310, a spacer layer 320 with plural spacers and a second substrate layer 330. Since the inner surfaces of the first substrate layer 310 and the second substrate layer 330 include an electrode layer respectively, the proximity-sensing units 140 may be formed on the inner surfaces of the first substrate layer 310 and the second substrate layer 330. Here the proximity-sensing units 140 are formed on one or more perimeter(s) inside the substrate panel 320.

According to the embodiments disclosed above, a proximity-sensing method of a panel is also disclosed in parallel. The panel includes a substrate panel, proximity-sensing units and sensing circuits; wherein the substrate panel includes a touch surface to receive a touch input and the sense circuits electrically connect with the proximity-sensing units. And the method includes the following steps.

(A) Forming the proximity-sensing units on perimeter(s) of the substrate panel.

(B) Sense an approach operation of an object and generating a proximity-sensing signal by the proximity-sensing unit.

(C) Receive the proximity-sensing signal from the proximity-sensing unit and generate a control signal accordingly to initiate a proximity control.

To form an all-flat or frameless touch screen, the substrate panel according to the present invention may include a glass substrate panel, a plastic substrate panel or an acrylic substrate panel used as at least a cover lens of any touch panel and/or display panel; the proximity-sensing units disclosed in the present invention may be formed underneath the aforesaid cover lens. Some of the sensing circuits are omitted in the drawings mentioned below.

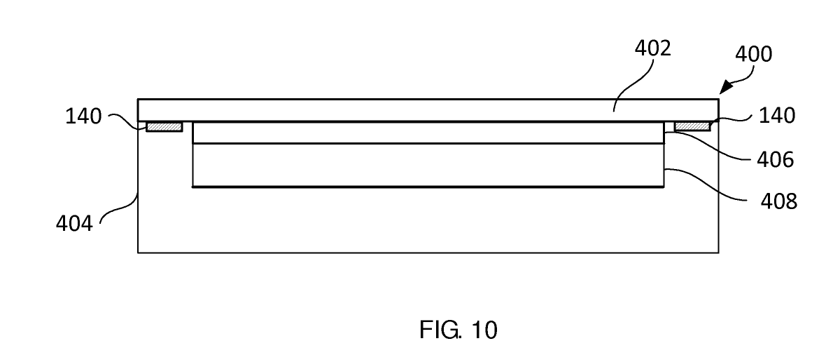

Please refer to FIG. 10, which is a cross-sectional structural view of an all-flat capacitive type proximity-sensing panel according to another embodiment of the present invention. An all-flat capacitive proximity-sensing panel 400 mainly includes a substrate panel having a cover lens 402, and capacitive-type proximity-sensing units 140. As shown in FIG. 10, a LCD panel 408 is assembled inside a housing 404, with a protection layer 406 located between the cover lens 402 and the LCD panel 408. The cover lens 402 covers on at least one side of the housing 404 to form the so-called frameless or all-flat structure. The capacitive-type proximity-sensing units 140 may be formed (e.g. at a perimeter) on the inner surface of the cover lens 402. As mentioned above, the cover lens 402 of the substrate panel may be a glass substrate panel, a plastic substrate panel (e.g. PET, Polyethylene Terephthalate) or an acrylic substrate panel. In another embodiment, the protection layer 406 may be replaced as a capacitive touch panel under the cover lens 402.

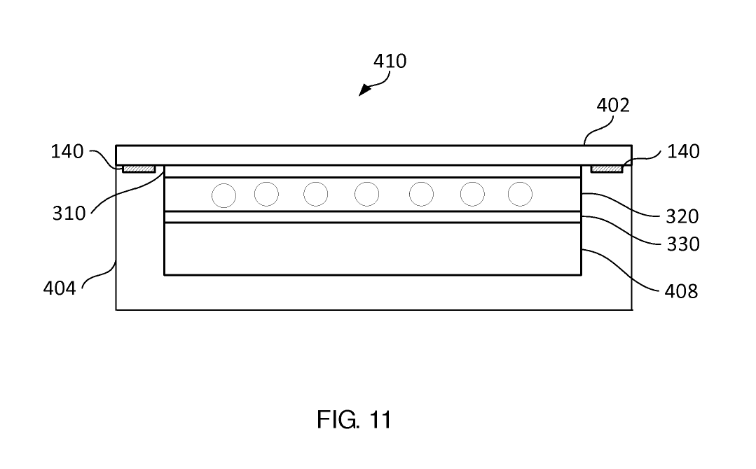

Please refer to FIG. 11, which is a cross-sectional structural view of an all-flat resistive type proximity-sensing panel according to another embodiment of the present invention. An all-flat resistive proximity-sensing panel 410 mainly includes a substrate panel and proximity-sensing units 140. The substrate panel includes a cover lens 402 and a resistive touch panel (namely a first substrate layer 310, a spacer layer 320 with plural spacers and a second substrate layer 330 with a LCD panel 408 located under the second substrate layer 330) located underneath the cover lens 402; wherein the first substrate layer, spacer layer 320, second substrate layer 330 and LCD panel 408 are assembled inside a housing 404. The cover lens 402 covers on at least one side of the housing 404 to form the so-called frameless or all-flat structure. The proximity-sensing units 140 may be formed (e.g. at a perimeter) on the inner surface of the cover lens 402.

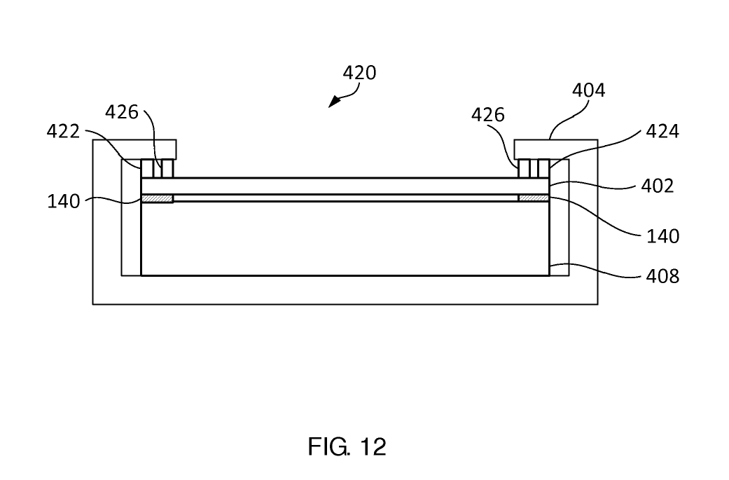

Please refer to FIG. 12, which is a cross-sectional structural view of an optical type proximity-sensing panel according to another embodiment of the present invention. An optical proximity-sensing panel 420 mainly includes proximity-sensing units 140, a cover lens 402 as the substrate panel, light transmitter(s) 422, light receiver(s) 424 and isolator(s) 426. The light transmitter 422 located on the outer surface of the cover lens 402 transmits a light or laser; and the light receiver 424 located at the other side on the outer surface of the cover lens 402 senses changes of the transmitted light to sense a touch input. Cover lens 402, light transmitter 422, light receiver 424, isolators 426 and LCD panel 408 (located underneath the cover lens 402) are assembled inside housing 404 with a touch surface of the cover lens 402 exposed outwardly. The proximity-sensing units 140 may be formed on the outer surface or inner surface of the cover lens 402; in FIG. 12, the proximity-sensing units 140 are formed on the inner surface of the cover lens 402.

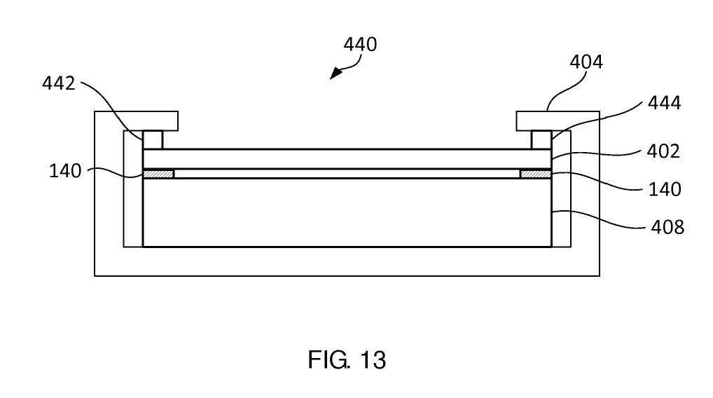

Please refer to FIG. 13, which is a cross-sectional structural view of an ultrasound-wave type proximity-sensing panel according to another embodiment of the present invention. An ultrasound-wave type proximity-sensing panel 440 mainly includes proximity-sensing units 140, cover lens 402 as the substrate panel, ultrasound-wave transmitter 442 and ultrasound-wave receiver 444. The ultrasound-wave transmitter 442 located on the outer surface of the cover lens 402 transmits an ultrasound wave; and the ultrasound-wave receiver 444 located at the other side on the outer surface of the cover lens 402 senses changes of the transmitted ultrasound wave to sense a touch input. Cover lens 402, ultrasound-wave transmitter 442, ultrasound-wave receiver 444 and LCD panel 408 (located underneath the cover lens 402) are assembled inside housing 404 with a touch surface of the cover lens 402 exposed outwardly. The proximity-sensing units 140 may be formed on the outer surface or inner surface of the cover lens 402; in FIG. 13, the proximity-sensing units 140 are formed on the inner surface of the cover lens 402. Light, infrared and ultrasound wave basically have similar principles of touch sensing and all need energy transmitter and energy receivers to sense the changes of transmitted energy (light, infrared and ultrasound wave) to sense a touch input.

Moreover, capacitive proximity-sensing unit at least include self-capacitance proximity-sensing unit and mutual-capacitance proximity-sensing unit. The self-capacitive proximity-sensing unit uses at least one electrode (single-electrode) to drive its touch sensing operation and sense the touch inputs. On the other hand, the mutual-capacitance proximity-sensing unit uses at least two electrodes (dual-electrode) to drive and sense.

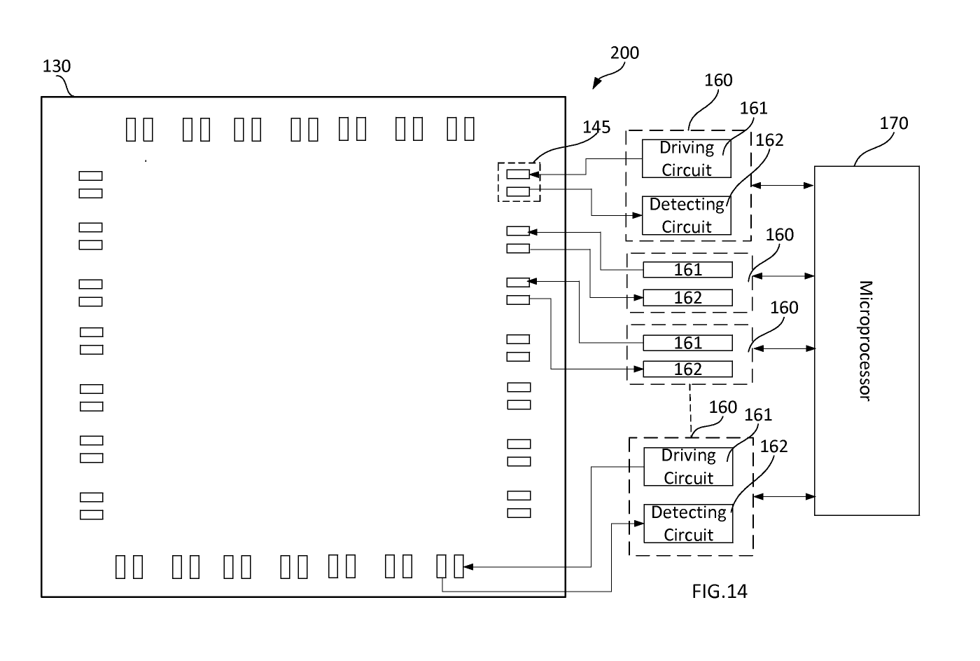

Please refer to FIGS. 14, 15, 16, 17 and 18, which are system block diagrams of five proximity-sensing panels with five different types of capacitive proximity-sensing units according to other embodiments of the present invention.

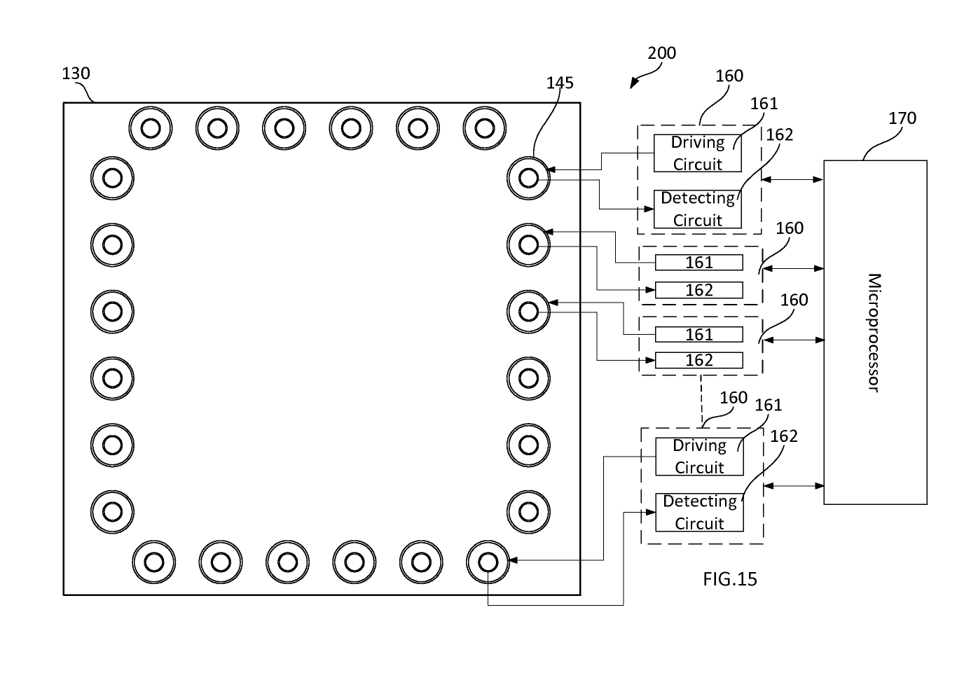

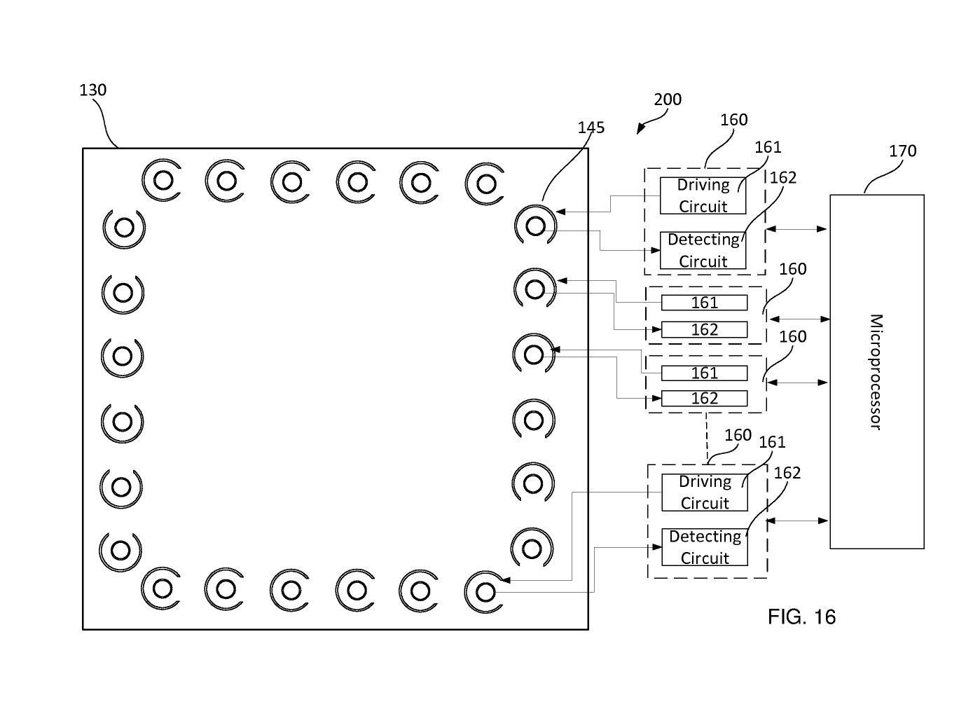

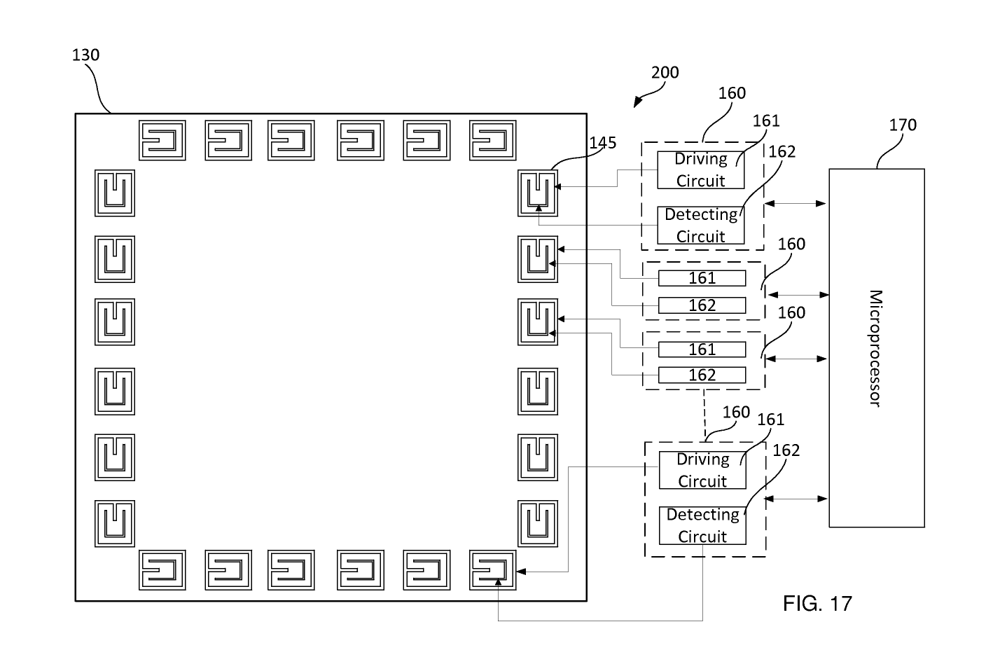

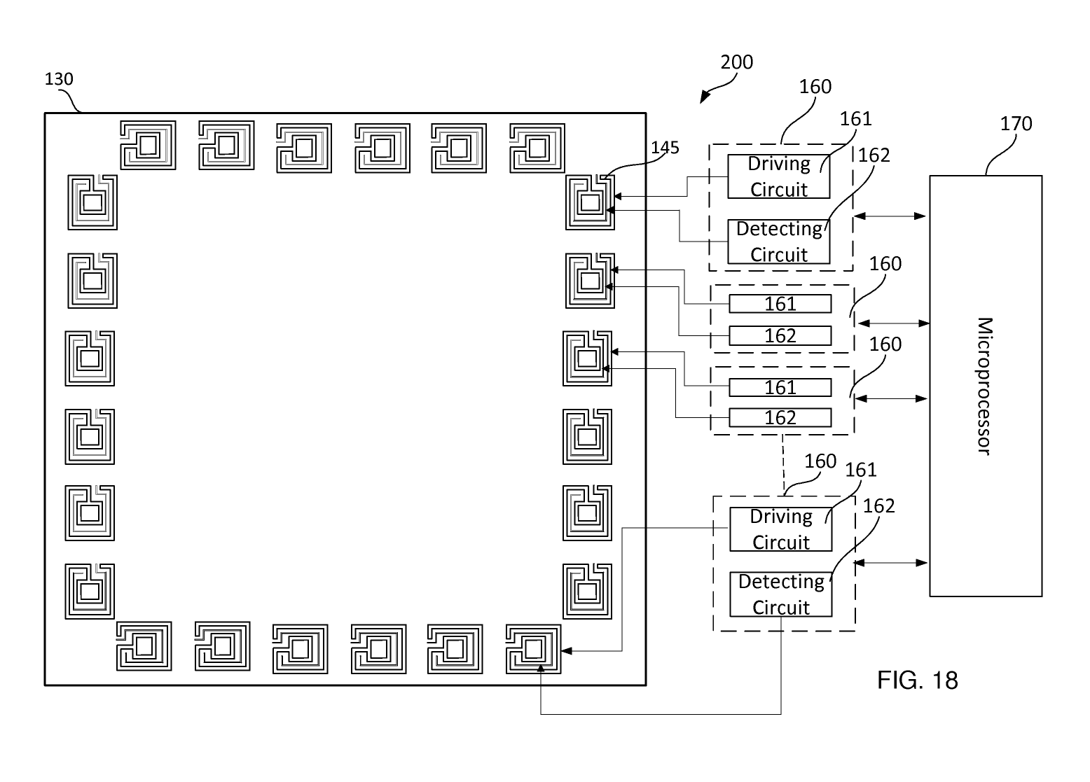

At least one mutual-capacitance proximity-sensing unit 145 is formed at a perimeter of the substrate panel. The mutual-capacitance proximity-sensing unit 145 includes two electrodes to sense an approaching operation of an object and generate a sensing signal. The structure of the mutual-capacitance proximity-sensing unit varies. In FIG. 14, the structure of the two electrodes of the mutual-capacitance proximity-sensing unit 145 is defined as “Dual Parallel Rectangles” with two rectangular electrodes aligned in parallel. In FIG. 15, the structure of the two electrodes of the mutual-capacitance proximity-sensing unit 145 is defined as “Concentric Circles” with two circle electrodes having the same center. In FIG. 16, the structure of the two electrodes of the mutual-capacitance proximity-sensing unit 145 is defined as “Arc Surrounding Circle”, in which an arc electrode surrounds a smaller circle electrode. FIG. 17, the structure of the two electrodes of the mutual-capacitance proximity-sensing unit 145 is defined as “Concentric Rectangles”, in which a rectangular electrode with an end extended inwards surrounds an U-shaped electrode; wherein the extended end of the rectangular electrode points out a direction towards an opening of the US-shaped electrode. In FIG. 18, the structure of the two electrodes of the mutual-capacitance proximity-sensing unit 145 is defined as “Concentric Rectangular Labyrinth”; wherein an electrode routes along an opened outer rectangle with a closed inner rectangle ending inside the opened rectangle, and the other electrode routes along the gap between the outer and inner rectangles.

Please refer to the sensing circuits shown in FIGS. 14, 15, 16, 17 and 18. Sensing circuit 160 includes a driving circuit 161 and detecting circuit 162. Taking FIG. 14 as an example, mutual-capacitance proximity-sensing unit 145 includes at least two electrodes, a first electrode and a second electrode. The operation principles of using the mutual-capacitance proximity-sensing unit 145 to sense the approaching operation of an object are as follows. Driving circuit 161 drives a signal to the first electrode connected to the driving circuit 161, while the second electrode generates a corresponding mutual-capacitance reaction. When object 10 is approaching the mutual-capacitance proximity-sensing unit 145, the capacitance of the mutual-capacitance proximity-sensing unit 145 is changed because of being interfered. At the moment, the detecting circuit 162 detects the capacitance changes according to the second electrode connected to the detecting circuit 162. Through the changes of voltage or current, the capacitance changes of the mutual-capacitance proximity-sensing unit 145 are able to be obtained, so as to calculate the distance between the approaching object and the touch panel. Using the mutual-capacitance proximity-sensing unit 145 achieves a faster response and a better stability.

In another embodiment according to the present invention, the substrate panel may further include a function area adapted for non-proximity touch control and the proximity-sensing unit is formed on the perimeter outside the function area. The substrate panel may be a non-proximity touch panel, or a display panel embedded with in-cell non-proximity touch control sensors. The substrate panel may further include a function area adapted to display images and the proximity-sensing unit is formed on the perimeter outside the function area. The substrate panel may be a display panel without touch control sensors.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A proximity-sensing panel, comprising:
a substrate panel, comprising a touch surface to receive a touch input;
at least one proximity-sensing unit formed on at least one perimeter of the substrate panel, the proximity-sensing unit sensing an approaching operation of an object and generating a proximity-sensing signal; and
at least one sensing circuit, electrically connecting the proximity-sensing unit to receive the proximity-sensing signal and generating a control signal accordingly to initiate a proximity control.

2. The proximity-sensing panel according to claim 1, wherein the proximity-sensing unit is selected from the group consisting of a self-capacitance proximity-sensing unit, a mutual-capacitance proximity-sensing unit, an inductive proximity-sensing unit, a photoelectric proximity-sensing unit and a magnetic proximity-sensing unit.

3. The proximity-sensing panel according to claim 2, wherein the structure of two electrodes of the mutual-capacitance proximity-sensing unit is selected from a group consisting of Dual Parallel Rectangles, Concentric Circles, Arc Surrounding Circle, Concentric Rectangles and Concentric Rectangular Labyrinth.

4. The proximity-sensing panel according to claim 1, wherein the proximity-sensing unit is selected from the group consisting of round shape, rectangular shape, elliptic shape, star shape, heart shape, spiral shape, and hollow shape.

5. The proximity-sensing panel according to claim 1, wherein the proximity-sensing unit comprises:
a light transmitter, transmitting a light; and
a light receiver, receiving the transmitted light and generating the proximity-sensing signal according to a light intensity of the transmitted light.

6. The proximity-sensing panel according to claim 1, wherein the proximity-sensing unit comprises at least one magnetic sensing element to sense an eternal magnetic object, the proximity-sensing signal being generated when two switch contacts of the magnetic sensing element are contacted to connect with each other.

7. The proximity-sensing panel according to claim 1, wherein the substrate panel is selected from a group consisting of a projective capacitive touch panel, a surface capacitive touch panel, a resistive touch panel, an ultrasonic touch panel, an infrared touch panel, an OLED (Organic Electroluminescent Display) substrate panel, a LCD (Liquid Crystal Display) substrate panel, an EPD (E-Paper Display) substrate panel, a glass substrate panel, a plastic substrate panel and an acrylic substrate panel, or any combination thereof.

8. The proximity-sensing panel according to claim 1, wherein the proximity-sensing unit is selectively formed on a top surface, a bottom surface, or a lateral surface of the substrate panel, or on both the top surface and bottom surface of the substrate panel.

9. The proximity-sensing panel according to claim 1, wherein the proximity-sensing unit is formed inside or outside the substrate panel.

10. The proximity-sensing panel according to claim 1, wherein the substrate panel further comprises a function area adapted for non-proximity touch control and the proximity-sensing unit is formed on the perimeter outside the function area.

11. The proximity-sensing panel according to claim 10, wherein the substrate panel is a non-proximity touch panel, or a display panel embedded with in-cell non-proximity touch control sensors.

12. The proximity-sensing panel according to claim 1, wherein the substrate panel further comprises a function area adapted to display images and the proximity-sensing unit is formed on the perimeter outside the function area.

13. The proximity-sensing panel according to claim 12, wherein the substrate panel is a display panel without touch control sensors.

14. The proximity-sensing panel according to claim 1, wherein the substrate panel comprises a projective capacitive type touch panel with a substrate layer, a first electrode layer forming at a top side and a second electrode layer forming at a bottom side, the proximity-sensing units being selectively formed at the top surface of the first electrode layer, at the bottom surface of the second electrode layer or at both the top surface of the first electrode layer and the bottom surface of the second electrode layer.

15. The proximity-sensing panel according to claim 1, wherein the substrate panel comprises a resistive type touch panel with a first substrate layer, a spacer layer having at least one spacer and a second substrate layer, the proximity-sensing unit being formed on the inner surfaces of the first substrate layer and the second substrate layer.

16. The proximity-sensing panel according to claim 1, wherein the substrate panel comprises a cover lens with a touch panel under the cover lens, at least a portion of the touch panel with a display panel located under the touch panel being assembled inside a housing, the cover lens covering on at least one side of the housing, the proximity-sensing unit being formed on an inner surface or an outer surface of the cover lens.

17. The proximity-sensing panel according to claim 1, wherein the substrate panel comprises a cover lens with an energy transmitter and an energy receiver located on an outer surface of the cover lens, the cover lens, the energy transmitter, the energy receiver and a display panel located underneath the cover lens being assembled inside a housing with the touch surface of the cover lens exposed outwardly, the proximity-sensing unit being formed on an inner surface or the outer surface of the cover lens.

18. A proximity-sensing method of a panel with a substrate panel, at least one proximity-sensing unit and at least one sensing circuit, wherein the substrate panel comprises a touch surface to receive a touch input and the sense circuits electrically connects with the proximity-sensing unit, the method comprising:
forming the proximity-sensing unit on at least one perimeter of the substrate panel;
sensing an approaching operation of an object and generating a proximity-sensing signal by the proximity-sensing unit; and
receiving the proximity-sensing signal from the proximity-sensing unit and generating a control signal accordingly to initiate a proximity control.

19. The proximity-sensing method according to claim 18, wherein the proximity-sensing unit is formed inside or outside the substrate panel.

20. The proximity-sensing method according to claim 18, wherein the substrate panel further comprises a function area adapted for non-proximity touch control and the proximity-sensing unit is formed on the perimeter outside the function area.

21. The proximity-sensing method according to claim 20, wherein the substrate panel is a display panel embedded with in-cell non-proximity touch control sensors or a non-proximity touch panel.

22. The proximity-sensing method according to claim 18, wherein the substrate panel further comprises a function area adapted to display images and the proximity-sensing unit is formed on the perimeter outside the function area.

23. The proximity-sensing method according to claim 22, wherein the substrate panel is a display panel without touch control sensors.
